(19) United States
(12) Patent Application Publication
(10) Pub. No.: US 2016/0140804 A1
(43) Pub. Date: May 19, 2016

(54) MOBILE APPLICATION FOR PEER-TO-PEER FANTASY SPORTS AND WAGERING

(71) Applicant: Stake Mobile Corporation, Scottsdale, AZ (US)

(72) Inventor: Ryan W. Morgan, Scottsdale, AZ (US)

(73) Assignee: Stake Mobile Corporation

(21) Appl. No.: 14/945,098

(22) Filed: Nov. 18, 2015

Related U.S. Application Data
(60) Provisional application No. 62/081,543, filed on Nov. 18, 2014.

(51) Int. Cl. G07F 17/32

(52) U.S. Cl. CPC G07F 17/3244; G07F 17/3272

(57) ABSTRACT

A computer-implemented method performed by a gaming server, comprising: receiving a join offer from a first user device of a first user of a user community, wherein the join offer identifies a first sports team to populate a first selection of players; providing the join offer to members of the user community including a second user of the user community having a second user device; receiving, from the second user device, an acceptance of the join offer identifying a second team to populate a second selection of players; scoring the first user based on the performance of each player of the first selection of players in a designated athletic event corresponding to each player; scoring the second user using the second selection of players; and awarding a prize to either the first user or the second user as determined by which received a higher score.

### CROSS-REFERENCE TO RELATED APPLICATIONS

This application incorporates by reference and claims the benefit of priority to U.S. Provisional Patent Application No. 62/081,543 filed Nov. 18, 2014.

### BACKGROUND OF THE INVENTION

The present invention relates to systems for fantasy sports competition and wagering. Specifically, the present invention relates to a mobile application for the creation and execution of a peer-to-peer gaming interface where all of those competing in fantasy sports and/or wagering are within a specific community (including ad hoc “flash communities”) coordinated through the application

Competition defines sports. It satisfies a gut level instinct to strive, to fight, to succeed. Unsurprisingly, many sports fans want more than to be passive observers of sports, they want to be part of the action. This primal drive to compete, even among the fans, may be the source of the massive growth in fantasy sports and sports betting.

Fantasy sports and sports betting has long tapped into the competitive spirit of fans. However, there are many drawbacks to previously existing fantasy sports and sports betting systems. First, there are severe access limitations. Many jurisdictions forbid sports betting. Accordingly, most legal, organized sports betting occurs in places far from the action, such as Las Vegas. This means for most fans, there are no options to compete in fantasy sports or to bet on the competition while attending an event in a stadium or arena. Even when fantasy sports or sports betting can be accessed remotely, for example, using mobile applications provided by casinos, the offerings often generally replicate the sports book's offering and lack engaging peer to peer features that allow the fans to compete against one another.

Other previous wagering systems involve social apps to record bets. These social apps are basically a forum for posting and recording bets so they can be referenced later. These systems do not provide a mechanism for creating a platform amongst groups of two or more users for fantasy sports competitions and/or wagers for offer and acceptance via a mobile smartphone and/or tablet or other mobile device application platform and managing the results of the competition and/or wager.

Additionally, sports fans desire new ways to enjoy paid fantasy sports competitions where they compete for cash prizes or other valuable consideration. Fantasy sports have grown in popularity, but they are highly technical in nature with competitors picking their team player by player; our invention allows more casual players to easily field competitive teams in their fantasy sports competitions. Also, users desire to create fantasy teams that are composed in whole, in part, or primarily of players from their favorite team, or to events there are interested in and/or attending. Accordingly, there is a need for new approaches to fantasy sports wagering that engages casual users by allowing a simple way for users to select their fantasy team based on pre-filled teams or otherwise.

Accordingly, there is a need for a mobile application for the creation and execution of a peer-to-peer fantasy sports and/or gaming interface where all of those competing and/or wagering are identifiable within a specific community, as described herein.

### BRIEF SUMMARY OF THE INVENTION

The invention is a mobile application for the creation and execution of a peer-to-peer gaming interface where all of the users competing in fantasy sports and/or wagering are within a specific community (including ad hoc “flash communities”) that may be coordinated through the mobile application via an Administrator. For example, an example community may be users of the application that are physically in attendance at a particular stadium or arena where a sporting event is taking place. The application may form the community by locating users within a geo-fence, identifying the users by means of a beacon, using other geo-location based technology available now and in the future, entering a code which is provided at the specific location, or simply requiring that the user personally certify that they are in attendance at the event. The users in the community may compete and/or bet against each other in a variety of different ways within the community. The application may communicate with remote servers that coordinate games between users of the mobile application and assist in providing the functionality described herein. The remote servers may include servers managed by administrator and/or hosted by a third party such as a cloud service, such as a mobile fantasy sports and/or betting business that provides the mobile application. The remote servers may resolve all of the fantasy sports competitions or betting competitions using sports data obtained from the event operator or third parties or otherwise documented by the administrator.

In one example, users may compete with one another for a cash prize in fantasy sports games in the application. In one embodiment, a flash community may be formed in the stadium or arena where a specific sporting event is taking place. The users of the application within the stadium or arena may be permitted to select and/or draft a fantasy team from the participants on the teams participating in the game or match. This permits the administrator of the fantasy sports contests or wagers to partner or otherwise verify with the event operators, event marketers and rights holders to track and monitor and also to participate in the promotion, advertising, control, financial benefit, related marketing and administration of the fantasy games and/or wagers.

The application may be used to compete in (or bet on) on a variety of different fantasy sports games & contests. Fantasy sport games generally permit participants to act as owners to build a team of sports players that competes against other fantasy owners' teams based on certain statistics generated by the real individual players or teams of a professional sport. For example, the users may be permitted to play variations of daily fantasy sports that permit users to enter competitions (and/or wager) on games played on the same day.

A community may be formed in variety of ways. For example, the administrator may define a geofence around a strategic location, such as a stadium or arena where a sports event is taking place. In some embodiments, the geofence may include multiple areas to incorporate partner and affiliated locations such as restaurants, bars or even entire cities, states or countries. Geofences may include a temporal component, for example, a time period around the sports event, such as the day of the event, or a few hours before, during, and after the event. When a user logs into the application, the mobile device may determine the user's location and use the location as an authentication token to access a community.

Additionally, a community may be formed by invitation from the administrator; for example, the administrator may provide an access code to users to permit them to join the community. In other embodiments, a beacon (such as a transmitter or tower or other related technology) may permit users in a broadcast area to join the community. The beacon may broadcast an authentication token that the mobile device includes with a request to find and/or join a community. In some embodiments, the user may also, independent of any technological component, certify that he/she is at a specified location and thereby gain access to the community for the contests and/or wagers.

In an embodiment, after a user logs in and joins or is assigned to a community, a user may start in the community lobby on the mobile application. The user may choose to join (and compete in) a pre-existing contest created by another user in the community. Alternatively, the user may create a contest and post it in the lobby. When creating a contest, the user may select the entry fee and/or contested amount & prize or choose a free practice contest. The user may offer or enter as many games and teams as he likes to increase his chances of winning and these offers may be registered, displayed and tracked in a user's profile. A contest may be peer-to-peer to permit a user to go head-to-head with another member of the community, or may include more than two users, such as a team game of five users on each respective side of the contest. In some embodiments, a user may include a house component for the user to bet against. For example, when a user is in a stadium, the owner of the sports team may act as the “house” with which the user may bet against. Additionally, a casino operator may be able to make a user account and post numerous “offers” at any given time for contests or wagers relating to the specific community that may be accepted by other users and members of the community.

Once the user has chosen a contest he will pick his ultimate fantasy team for that day or week's games. In an embodiment, the user may choose players from all teams playing during a period, such as that week, that day, etc. In some embodiments, the user may choose a “Quick Team” option to have his players selected algorithmically or otherwise by the Administrator's system. The user would also, in some embodiments, have the opportunity to edit the membership of the sports players picked by the Administrator to his “Quick Team”. The players may be chosen by the Administrator in any manner that the Administrator deems fit, based on a mathematical algorithm, based on the players' prior performance, based on the user's prior preferences for players or players on a certain team, or based on other factors the Administrator determines. In some embodiments, the user will have the opportunity to edit the team, no matter how it is chosen, to give the user his best chance of winning his competitions and/or wagers.

In other embodiments, the user may select a “Team Slate” option to have his team populated entirely or substantially with players from a single team. For example, if the user is a fan of Team A and is at a game or match between Team A and Team B, the user may choose a Team Slate including all of, or a subset of players from Team A and his offer may be accepted by a user who selects a “Team Slate” composed entirely or substantially of players from Team B. In some embodiments, the Team Slate may automatically include one or more players from other teams, for example, a user with a “Team Slate” of Team A may be granted by the Administrator (or personally draft/select) one or more additional players from Team C. This may permit novel gameplay elements and may permit the mobile application to comply with the fantasy sports exemption of the Unlawful Internet Gambling Enforcement Act.

In some embodiments, the user may be able to select and/or acknowledge his wager and/or fantasy team for the competition with one “push” of a button on his mobile device, one swipe across the screen, or another “simple” tactical or other type of recognition set by the Administrator on the mobile device (double swipe, double tap, side swipe, or a custom gesture recognition interface via the mobile device set by the user or the administrator (thumbs up gesture, OK symbol, etc.). In these embodiments, the Quick Team, Team Slate, or other suggestion from the Administrator based on an algorithm or the user's prior preferences within the application may be a prefill option (along with the user's customary contest entry or wager amount which could also be modified) and the user can simply acknowledge with one of the above methods his fast entry into the contest or wager.

In some embodiments, the user may have constraints on the players he may choose, for example, the user may be assigned certain players or may be limited to choose from a specific group of players, players on teams participating in a specific event, a preselected team for a contest that he can “accept or pass” on, a salary cap wherein each player has an associated salary and the user may choose players subject to the condition that the combined salaries must not exceed a specified amount.

Once the users have selected, drafted, or been assigned their teams (and agreed on the competition terms such as the dollar amount of the entry), the game may begin. The players on a user's team accumulate points based on how they perform in their real-world matchups during the period of the game based on statistics chosen by the Administrator. If a user's team scores more points than the rival users during the period of the game, the user is awarded the winnings. In an embodiment, the administrator may choose statistics such as: runs in baseball, points in basketball, points in football, goals in soccer, goals in hockey, runs and wickets in cricket.

In some embodiments, the mobile application may import news feed or data feeds pertaining to the event. These data feeds may include scores, player statistics, predictions, injury reports, etc. These data feeds may be displayed to the user before, after or during the period of time in which the user is choosing players/teams, or at the user's desire, or after a team has been assigned or otherwise selected by the user.

In some embodiments, the mobile application or the remote servers may generate a profile for a user of the application. The profile may be linked with third-party websites, such as social networks like Facebook, Twitter, Instagram, Snapchat, Linkedin, Tinder, Pinterest etc. The profile may include the favorite teams, favorite players, performance record, or other identifying characteristics of the user, and may be made public and/or visible to other users at the discretion of the administrator and/or the user depending on the settings within the mobile application.

The mobile application may include chat functionality to permit members of a community to communicate with one another. For example, the user may view other users in the community via their profile or the stadium/arena rendering and initiate a chat with any of them. The users may negotiate bets prior to an offer, or just build a community by joking around, taunting fans of the other team, etc. Additionally, the mobile application may integrate a chat function where users on the mobile application platform can automatically detect one another and choose by a method determined by the administrator to communicate within the application.

The mobile application may include a feature whereby the user can publish his thoughts, updates, results, etc. to the world at large via a third party platform that may be integrated by the Administrator. For example, the user may post a challenge to another user or potential users via Twitter, Facebook, Instagram, Snapchat, Pinterest or other digital media platforms

The mobile application may include push notification functions to permit advertising, sponsor notifications, etc. within the user interface featuring the fantasy sports competitions and/or wagers. For example, when the community is based around a specific sports event, the mobile application may receive push notifications from the promoters of the event or from the administrator on behalf of advertisers, promoters, etc. Such push notifications may include free offers for merchandise, concessions, coupons or offers to participate in additional contests, etc.

In an embodiment, a computer-implemented method performed by a gaming server in communication with a first user device and a second user device, includes the steps of: receiving a join offer from the first user device, wherein the first user device is a user device of a first user of a user community, wherein the join offer identifies a first sports team to populate a first selection of players, wherein the join offer includes a selection of a first player to exclude from the first selection of players and a selection of a second player to include in the first selection of players, wherein the first player is from the first sports team and the second player is from a sports team other than the first team; providing the join offer to members of the user community including a second user, wherein the second user device is a user device of the second user of the user community; receiving, from the second user device, an acceptance of the join offer, wherein the acceptance identifies a second team to populate a second selection of players; scoring the first user based on the performance of each player of the first selection of players in a designated athletic event corresponding to each player; scoring the second user based on the performance of each player of the second selection of players in a designated athletic event corresponding to each player; and awarding a prize to either the first user or the second user as determined by which received a higher score.

In an embodiment, the user device of the first user is assigned to the user community in response to receiving a location identifier from the user device of the first user. In some embodiments, the user community is associated with a real world sports event to be played between the first sports team and the second sports team. Additionally, in some embodiments, the acceptance of the join offer includes a selection of a first player to exclude from the second selection of players and a selection of a second player to include in the second selection of players, wherein the first player is from the second sports team and the second player is from a team other than the second team. Further, in some embodiments, the performance of each player is the number of points scored by the player.

In an embodiment, a peer-to-peer gaming system includes: a first user device; a second user device; and a gaming server configured to: receive a join offer from the first user device, wherein the first user device is a user device of a first user of a user community, wherein the join offer identifies a first sports team to populate a first selection of players, wherein the join offer includes a selection of a first player to exclude from the first selection of players and a selection of a second player to include in the first selection of players, wherein the first player is from the first sports team and the second player is from a sports team other than the first team; provide the join offer to members of the user community including a second user, wherein the second user device is a user device of the second user of the user community; receive, from the second user device, an acceptance of the join offer, wherein the acceptance identifies a second team to populate a second selection of players; score the first user based on the performance of each player of the first selection of players in a designated athletic event corresponding to each player; score the second user based on the performance of each player of the second selection of players in a designated athletic event corresponding to each player; and award a prize to either the first user or the second user as determined by which received a higher score.

In an embodiment, the user device of the first user is assigned to the user community in response to receiving a location identifier from the user device of the first user. And, in an embodiment, the user community is associated with a real world sports event to be played between the first sports team and the second sports team. In some embodiments, the acceptance of the join offer includes a selection of a first player to exclude from the second selection of players and a selection of a second player to include in the second selection of players, wherein the first player is from the second sports team and the second player is from a team other than the second team. Additionally, in some embodiments, the performance of each player is the number of points scored by the player.

In an embodiment, a non-transitory computer-medium which stores a program for peer-to-peer gaming, the program comprising instructions, that when executed by a controller that is in communication with a user interface and a gaming server, cause the controller to: receive from a user, via the user interface, a selection of a first sports team to populate a first selection of players, receive from a user, via the user interface, a selection of a first player to exclude from the first selection of players and a selection of a second player to include in the first selection of players, wherein the first player is from the first sports team and the second player is from a sports team other than the first team; transmit a join offer to the gaming server, wherein the join offer identifies the first sports team and the selected first player and the selected second player; and upon the remote server scoring the first selection of players based on the performance of each player of the first selection of players in a designated athletic event corresponding to each player and determining that a resulting score exceeds a score of a second selection of players, receiving a notification from the gaming server that the user has been awarded a prize.

An object of the invention is to provide a fantasy sports and wagering system to permit fans to create fantasy sports matchups that approximate betting on a live sports event.

An advantage of the invention is that it provides for communities to permit users to compete with other users attending or watching the same live sports event.

Another advantage of the invention is that it provides fantasy sports wagering where a user may create a fantasy sports team that is largely composed of players from a real world sports team.

A further advantage of the invention is that it provides a fantasy sports scoring system that tracks the outcome of a live sports event.

Yet another advantage of the invention is that it provides communities where fans of competing teams involved in a live event may compete against each other.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating an example peer-to-peer gaming system.

FIG. 2 is a schematic diagram illustrating an example user device of the peer-to-peer gaming system.

FIG. 3 illustrates an example of the scoring of a game between a first user and a second user.

FIG. 4 illustrates an example team slate selection screen of a gaming application of the peer-to-peer gaming system of FIG. 1 to permit a user to select a real world sports team as his or her team slate.

FIG. 5 illustrates an example confirm stake screen of a gaming application of the peer-to-peer gaming system of FIG. 1 to permit a user to review the chosen team slate and to increase or decrease a desired wager.

FIG. 6 is an example of a substitute player screen of a gaming application of the peer-to-peer gaming system of FIG. 1 to permit the user to choose one player to replace from a selected team.

FIG. 7 is an example of a current games screen of a gaming application of the peer-to-peer gaming system of FIG. 1 to view the currently active games for a user.

FIG. 8A is an example of a lobby screen of a gaming application of the peer-to-peer gaming system of FIG. 1 to enable the user to find existing games to join.

FIG. 8B illustrates an accept stake screen of a gaming application of the peer-to-peer gaming system of FIG. 1 to join a game created by another user.

FIG. 9 illustrates a method that may be executed by the gaming server of the peer-to-peer gaming system of FIG. 1 when carrying out the functionality described herein.

### DETAILED DESCRIPTION OF THE INVENTION

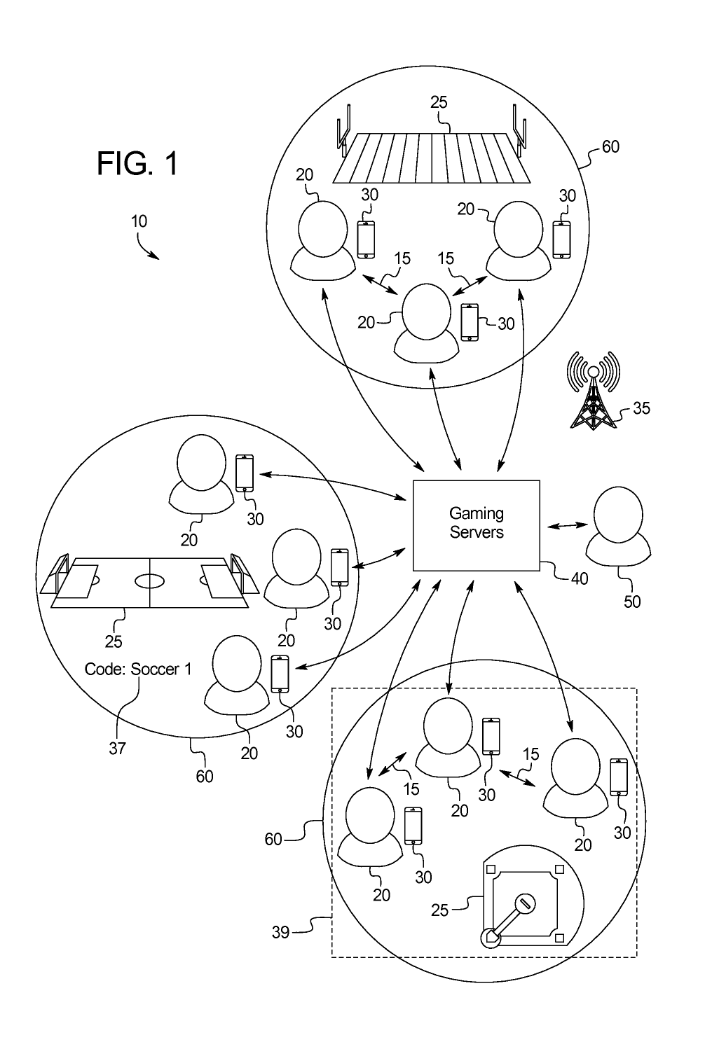

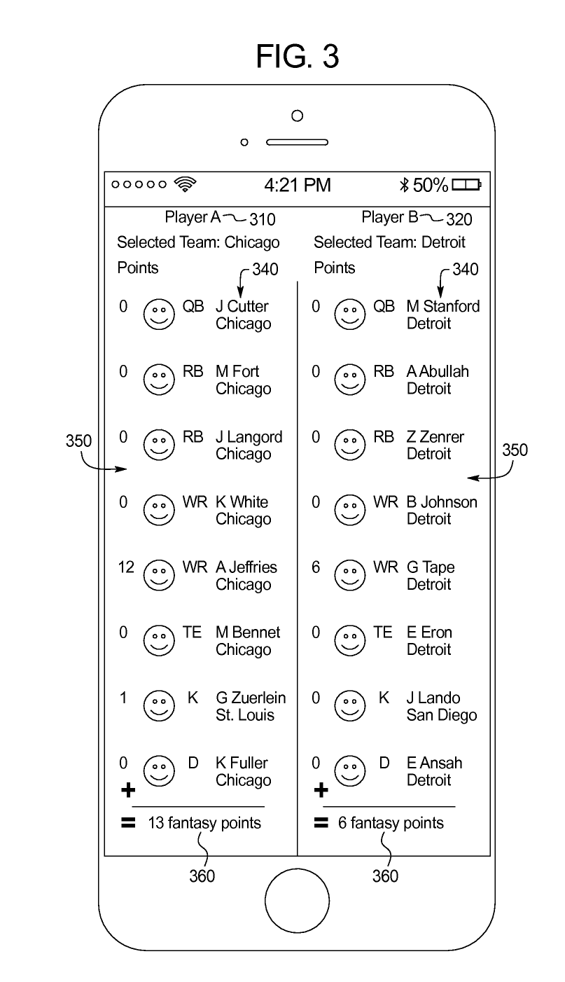

FIG. 1 illustrates an example of a peer-to-peer gaming system 10. As shown in FIG. 1, the peer-to-peer gaming system 10 may permit users 20 to use their mobile devices 30 to compete against each other in fantasy sports games 15. A fantasy sports game 15 is a game with rules that is played between two or more users 20 who each select athletes to populate a fantasy team 340 (FIG. 3). Each fantasy team 340 is scored from accumulated statistics of the fantasy team athletes as achieved in live sporting events. The user 20 who accumulates the highest score wins and may be awarded a prize.

To create an exciting and fun experience, the peer-to-peer gaming system 10 may encourage fans of teams that are playing in a live event to compete against each other. In an embodiment, users 20 may be grouped into various communities 60. For example, one form of community 60 may be a flash community 60 that is formed from those users 20 who are in the vicinity of a sports arena 25 on the day of a live sporting event. Users 20 within a community 60 may be matched to compete in a peer-to-peer fantasy sports game 15.

Various gaming servers 40 may coordinate the games between the users 20. For example, gaming servers 40 may track the points scored by the fantasy team of each user 20 in a game 15. The gaming servers 40 may include a database of users 20 to match for games 15. In various embodiments, the gaming servers 40 and the user devices 30 coordinate to carry out the functionality of the peer-to-peer gaming system 10. Accordingly, it will be apparent to those of skill in the art from the disclosure herein that functionality described herein for the users devices 30 may, in some embodiments, be accomplished by the gaming servers 40, and conversely, the functionality described herein for the gaming servers 40 may, in some embodiments, be accomplished by the user devices 30.

The gaming servers 40 may include servers managed by administrator and/or hosted by a third party such as a cloud service, such as a mobile fantasy sports and/or betting business that provides the mobile application. The gaming servers 40 may resolve all of the fantasy sports competitions or betting competitions using sports data obtained from the event operator or third parties or otherwise documented by the administrator.

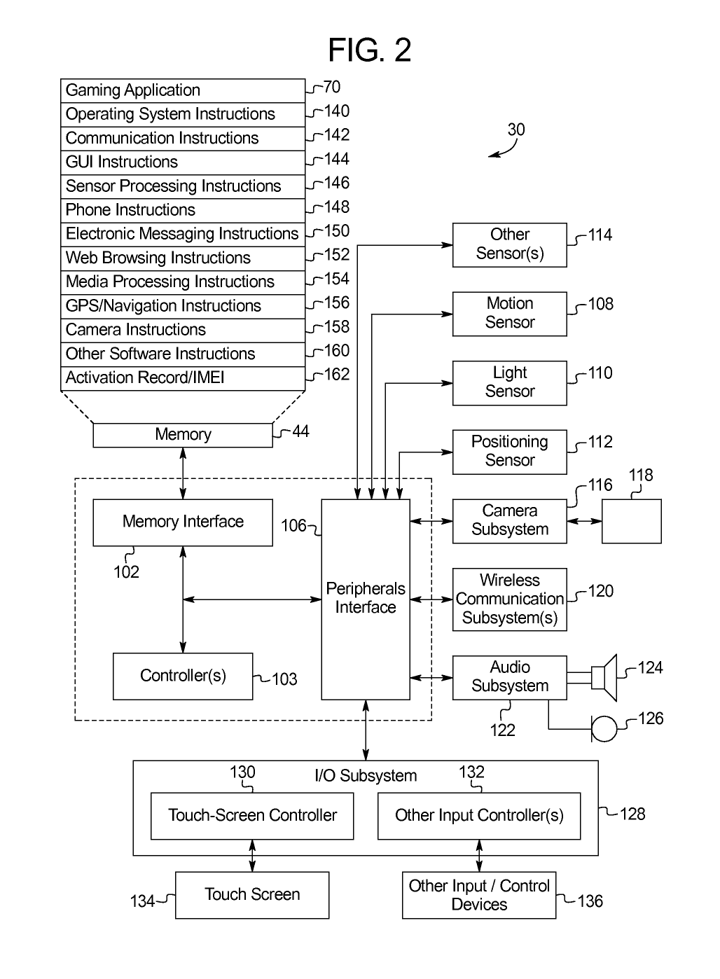

As shown in FIG. 2, the user device 30 may be a user device 30, such as a smartphone, running a gaming application 70 to provide the functionality described herein. The user 20 may install the gaming application 70 on his or her user device 30 and launch it to join a game 15. The user device 30 may include wireless communication subsystem 120 to communicate with one or more gaming servers 40.

As noted, communities 60 may be formed on an ad hoc basis. These flash communities 60 may be group users 20 in a particular area. For example, an example community 60 may be users 20 of the gaming application 70 that are physically in attendance at a particular stadium or arena 25 where a sporting event is taking place. The gaming application 70 may form the community 60 by locating users 20 within a geo-fence, identifying the users by means of a beacon 35, or using any other geo-location based technology as will be understood by those of skill in the art from the examples provided herein. Additionally, a community 60 may formed by permitting users 20 to enter a code 37 which may provided at the specific location, or simply requiring that the user personally certify that they are in attendance at the event. The users 20 in the community 60 may compete and/or bet against each other in a variety of different ways within the community 60. As noted, communities 60 may be formed in a variety of manners, further, in some embodiments, a community 60 may include all users 20 of the peer-to-peer gaming system 10.

In an embodiment, administrators 50 may define a community 60. For example, an administrator 50 may define a geofence 39 around a strategic location, such as a stadium or arena 25 where a sports event is taking place. In some embodiments, the geofence 39 may include multiple areas to incorporate partner and affiliated locations such as restaurants, bars or even entire cities, states or countries. Geofences 39 may include a temporal component, for example, a time period around the sports event, such as the day of the event, or a few hours before, during, and after the event. When a user 20 logs into the gaming application 70, the mobile device 30 may determine the user's location and use the location as an authentication token to access a community.

Additionally, a community 60 may be formed by invitation from the administrator 50; for example, the administrator 50 may provide an access code 37 to users to permit them to join the community 60. In other embodiments, a beacon 35 (such as a transmitter or tower or other related technology) may permit users 20 in a broadcast area to join the community 60. The beacon 60 may broadcast an authentication token that the mobile device 30 includes with a request to find and/or join a community. In some embodiments, the user 20 may also, independent of any technological component, certify that he or she is at a specified location and thereby gain access to the community 60 for the contests and/or wagers.

Each flash community 60 may be administered by various administrators 50 via the gaming servers 40. For example, an administrator 50 may create and operate a flash community 60 in the vicinity of a sports arena 25 on the day of a live sporting event. The flash community 60 may permit fans of one team in the event to compete against fans of the opposing team. The gaming application 70 may communicate with gaming servers 40 that coordinate games between users 20 of the gaming application 70 and assist in providing the functionality described herein. Using the gaming servers 40, an administrator may control the awarding and distribution of prizes, provide incentives for competing in games 15, restrict the use of cash prizes, etc.

In one example, users 20 may compete with one another for a cash prize in fantasy sports games in the gaming application 70. For example, a flash community 60 may be formed in the stadium or arena 25 where a specific sporting event is taking place. The users 20 of the application within the stadium or arena 25 may be permitted to select and/or draft a fantasy team 340 (FIG. 3) from the athletes on the teams participating in the game or match. This permits the administrator 50 of the fantasy sports contests or wagers to partner or otherwise verify with the event operators, event marketers and rights holders to track and monitor and also to participate in the promotion, advertising, control, financial benefit, related marketing and administration of the fantasy games and/or wagers.

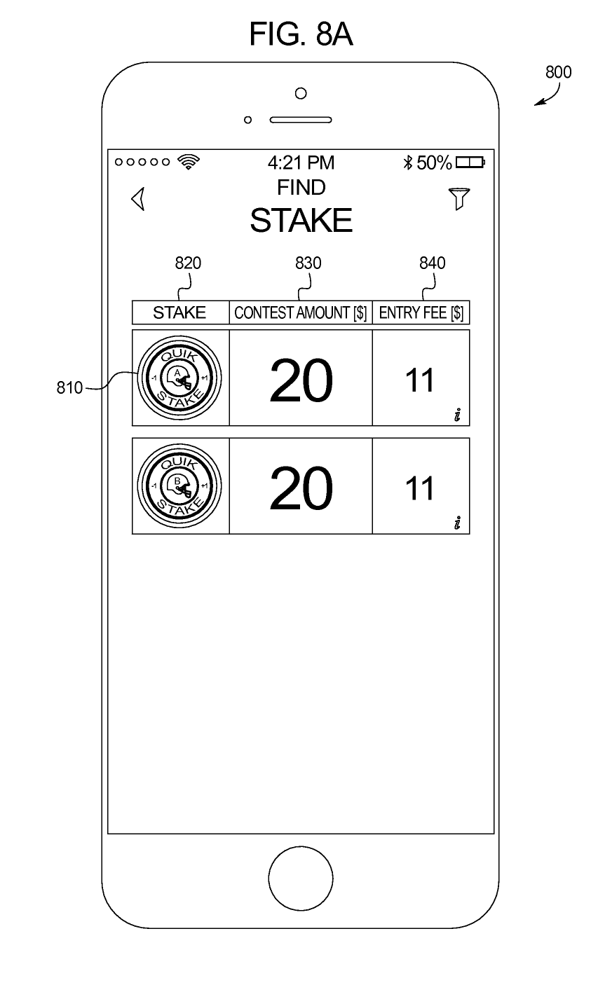

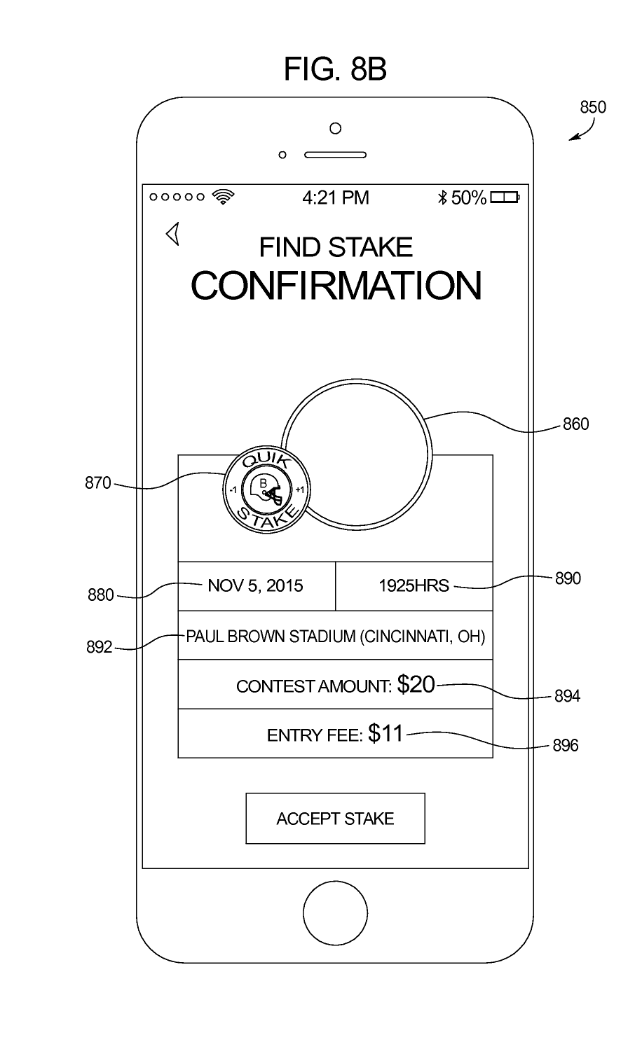

The user 20 may user the gaming application 70 to compete in (or bet on) on a variety of different fantasy sports games & contests. In an embodiment, after a user 20 logs in and joins or is assigned to a community 60, the user 20 may start in the community lobby screen 800 (FIG. 8A) of the gaming application 70. The user 20 may then choose to join (and compete in) a pre-existing game 15 created by another user in the community. The user 20 may view games for various sports (baseball, football, etc.) and search for matchups based on the teams involved.

Alternatively, the user 20 may create a game and post it in the lobby 800. When creating a game, the user 20 may select the entry fee and/or contested amount & prize or choose a free practice contest. The user 20 may offer or enter as many games and teams as he likes to increase his chances of winning and these offers may be registered, displayed and tracked in a user's profile. To populate the games 15 in the lobby, the gaming servers 40 may transmit join offers to the user device 30 for all games 15 that are still available to accept further users 20. A user 20 may click on an available game 15 in the lobby and create a fantasy team 340 to accept the join offer.

A game 15 may be peer-to-peer to permit a user 20 to go head-to-head with another member of the community, or may include more than two users 20, such as a team game of five users on each respective side of the game 15. In some embodiments, a user 20 may include a house component for the user 20 to bet against. For example, when a user 20 is in a stadium, the owner of the sports team may act as the “house” with which the user 20 may bet against. Additionally, a casino operator may be able to make a user account and post numerous “offers” at any given time for contests or wagers relating to the specific community that may be accepted by other users and members of the community.

In some embodiments, the user 20 may choose a “Quick Team” option to have the players on his or her fantasy team 340 (FIG. 3), selected algorithmically or otherwise by the gaming servers 40. The user 20 may also, in some embodiments, have the opportunity to edit the membership of the sports players 350 (FIG. 3) picked by the gaming servers 40 to populate the fantasy team 340. The players 350 may be chosen by the gaming server 40 in any manner that the administrator 50 deems fit, based on a mathematical algorithm, based on the players' prior performance, based on the user's prior preferences for players or players on a certain team, or based on other factors the administrator 50 determines. In some embodiments, the user 20 may have the opportunity to edit the fantasy team 340 and select a player 350 for each position, no matter how it is initially chosen, to give the user his best chance of winning his competitions and/or wagers.

FIG. 3 illustrates a game between a first user 310 and a second user 320 wherein each player has chosen a Team Slate. In an embodiments, the user 20 may select a “Team Slate” option to have his or her fantasy team 340 populated entirely or substantially with players 350 from a single real-world sports team. As shown in the example, if a first user 310 is a fan of the Chicago team and is at a game or match between the Chicago team and the Detroit team, the first user 310 may create a game 15 with a fantasy team 340 including all of, or a subset of players 250 from the Chicago team and his offer may be accepted by the second user 320 who selects a “Team Slate” composed entirely or substantially of players from Detroit. As shown, the fantasy team 340 may be awarded fantasy points 360 when a player 350 scores in the real world sports event.

As will be described below, in some embodiments, the team slate functionality may automatically include one or more players 350 from other teams, for example, a user 20 with a “Team Slate” of Chicago may be pre-populated with one or more additional players 350 from another team, for example, St. Louis. This may permit novel gameplay elements and may permit the gaming application 70 to comply with the fantasy sports exemption of the Unlawful Internet Gambling Enforcement Act by maintaining the element of skill when playing.

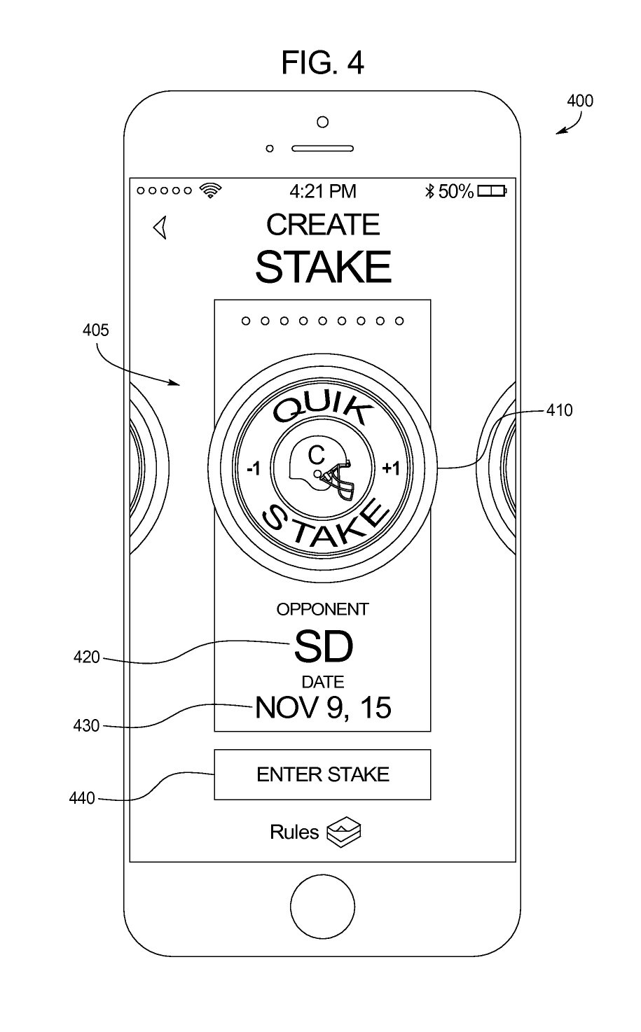

FIGS. 4-6 illustrate the steps in the gaming application 70 for creating or joining a game. A user 20 may begin by selecting a real world sports team as a Team Slate to use to populate his or her fantasy team 340. For example, FIG. 4 illustrates a team slate selection screen 400. The user 20 may swipe left or right to view the available teams 405 and select the desired team 405. For example, if the user 20 is choosing between football teams, the available teams 405 may include the Chicago Bears®, the Dallas Cowboys ®, etc. For a currently selected team 410, the team slate selection screen 400 may list the opposing team 420 in an upcoming event and list the date 430 of the event. When the user 20 has selected the desired team slate, the user 20 may press the enter stake button 440.

If the user 20 is a member of a current community 60, the available team slates in the team slate selection screen 400 may be limited to those team slates playing in an event associated with the community 60. For example, if the community 60 is based around a geofence associated with a football game between the Chicago Bears® and the San Diego Chargers®, then those teams may be the only options presented in the team slate selection screen 400.

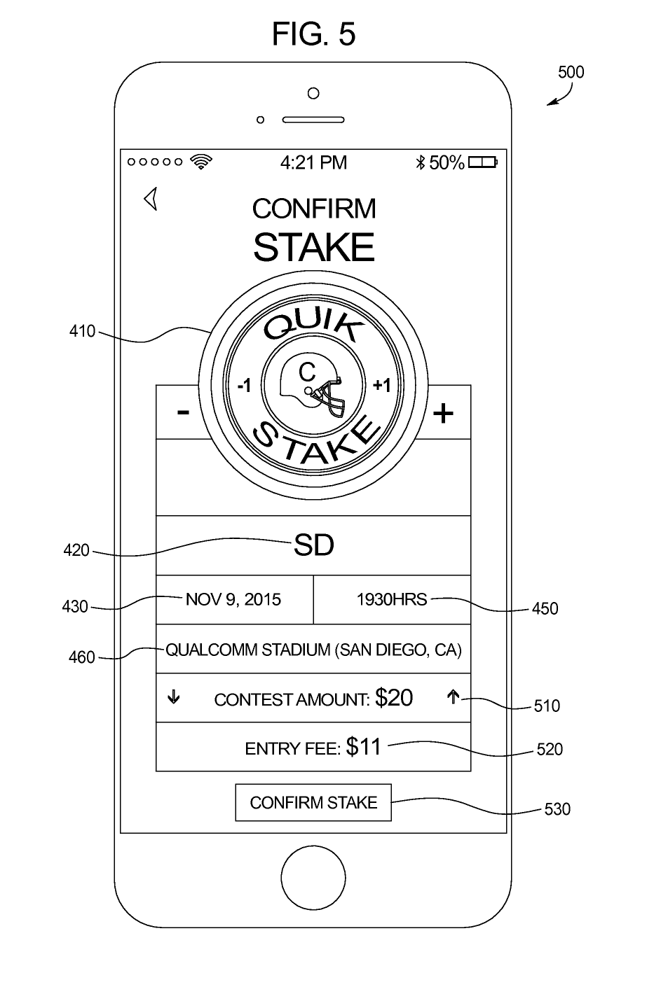

After the user 20 presses the enter stake button 440, the user 20 may be shown a confirm stake screen 500 shown in FIG. 5. The confirm stake screen 500 may list the selected team 410, the opposing team 420, the date 430 of the event, a time 450 of the event, and the location 460 of the event. The confirm stake screen 500 may include a game amount prompt 510 which may permit the user 20 to increase or decrease a game amount 510 for the game 15. The winner of the game 15 may be awarded the game amount 15 paid in by all the users 20 in a game 15. The confirm stake screen 500 may also include an entry fee 520 that may be set by the peer-to-peer gaming system 10. After review the details of the game listed on the confirm stake screen 500, the user 20 may click a confirm stake button 530. After the user 20 confirms the details of the game 15, the peer-to-peer gaming system 10 may populate a fantasy team 340 for the user 20 for the game 15 with players from the selected team 410.

In some embodiments, the user 20 may be able to select and/or acknowledge his wager and/or fantasy team for the competition with one “push” of a button on his mobile device, one swipe across the screen, or another “simple” tactical or other type of gesture on the user device 30 (double swipe, double tap, side swipe, or a custom gesture recognition interface via the mobile device set by the user or the administrator (thumbs up gesture, OK symbol, etc.)) set by the administrator 50. In these embodiments, the Quick Team, Team Slate, or other suggestion from the administrator 50 based on an algorithm or the user's prior preferences within the application may be a prefill option (along with the user's customary contest entry or wager amount which could also be modified) and the user 20 may simply acknowledge with one of the above methods his fast entry into the game 15.

In some embodiments, a user 20 may be permitted or required to substitute one or more players 350 from the selected team 410 with one or more players from other teams. For example, in an embodiment, the number of required substitutes may be two or more. In a preferred embodiment, only one substitution is allowed, and at least one substitution is required. In some embodiments, the removed player and the substitute player are pre-populated by the system 10.

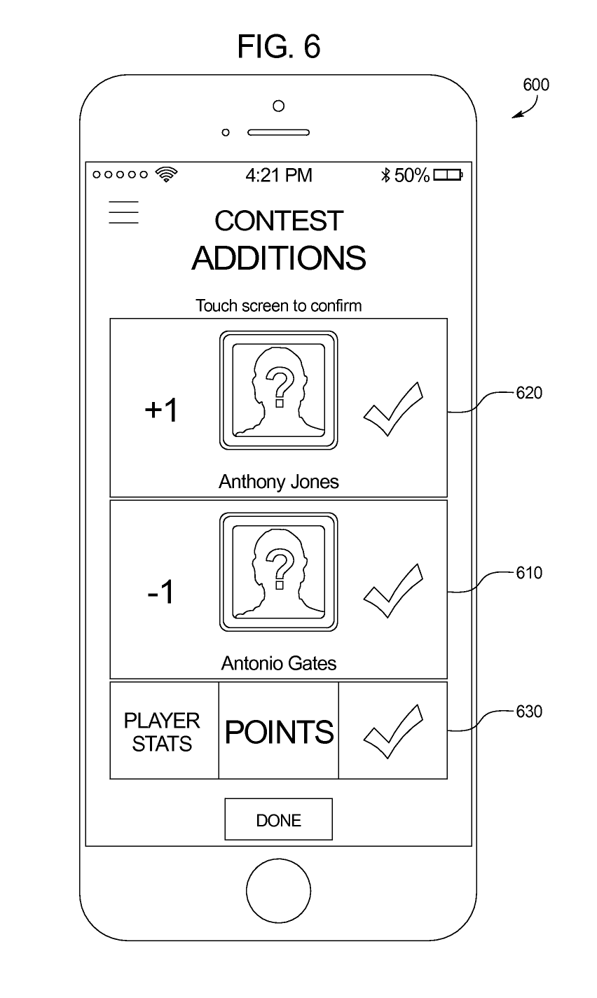

Shown in FIG. 6 is a substitute player screen 600. The substitute player screen 600 prompts the user 20 to select a first player 610 from the selected team 410 to remove from the fantasy team, and prompts the user 20 to select a second player 620 from a team other than the selected team 410 to include on the fantasy team. The user 20 may click on the first player 610 and the second player 620 to open lists of players to choose from. In the shown embodiment, the user 20 is be required to substitute at least one player from the fantasy team that is on the selected team 410 with another player from a team other than the selected team. This may be necessary to maintain compliance with the Unlawful Internet Gambling Enforcement Act. In some embodiments, each competing user 20 may be likewise required to and limited to replacing one player from the selected team.

Additionally, as shown in FIG. 6, when the user 20 is creating a game 15, he or she may select the player stats 630 that will be in the scoring of the team. In an embodiment, these scoring rules for each player 350 may be points scored by that player 350, such as runs, goals, touchdowns, extra points, etc. For example, a scoring rule for baseball may award points to a user 20 when any player 350 on the selected team 410 scores a run. In some embodiments, the scoring rules may be a single rule awarding points to each player on a team for each point made by the entire team.

After the user 20 has inputted a fantasy team 340, the gaming application 70 may transmit a join offer 810 to the gaming server. The join offer 810 encapsulates all of the information of the new game 15 and may include all the information collected in the team slate selection screen 400, confirm stake screen 500, and substitute player screen 600 including the selected team 410, the game amount 510, the substituted players, the player stats 630 to used to score the game 15, etc. The join offer 810 may be provided to users 20 of the community 60 who may accept the join offer 810.

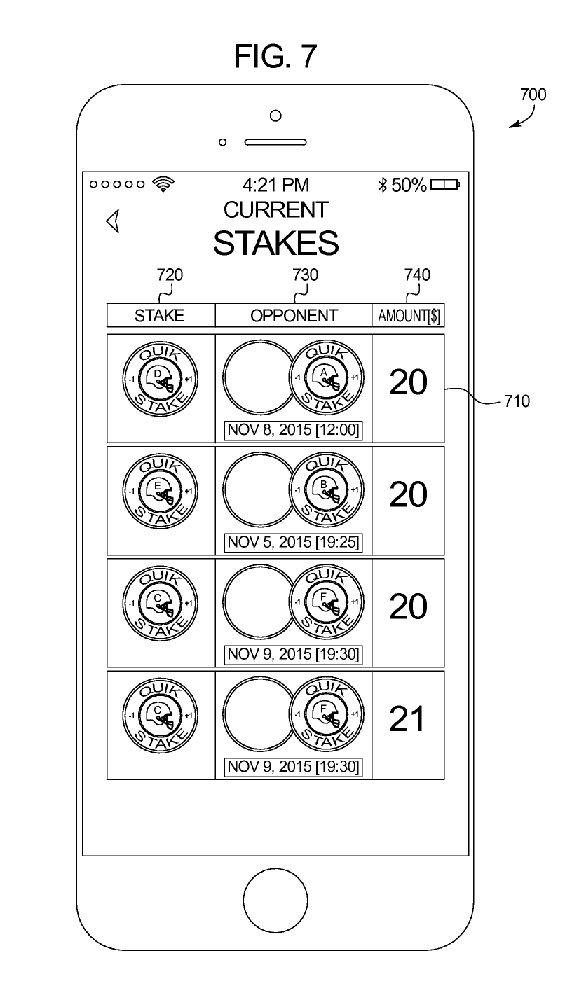

Shown in FIG. 7 is a current games screen 700. As shown, the current games screen 700 may list the current unfinished games of the user 20. For each game 710, the current games screen 700 may list the selected team 720 chosen as a team stake. Additionally, each opponent's profile picture and selected team 730 may be shown along with the amount bet 740 for each game 710.

Turning to FIGS. 8A and 8B, a user 20 may join a game 15 created by another user 20. In the lobby screen 800 shown in FIG. 8A, a user 20 may view available join offers 810. For each join offer 810, a team stake 820 of the creating user 860, a game amount 830 specified by the creating user 860, and an entry fee 840 may be displayed. To accept a join offer 810, the user 20 may click the desired join offer 810.

Next, the user 20 may be taken to an accept stake screen 850 as shown in FIG. 8B. The accept stake screen 850 may display a user profile picture 860 for the creating user 860, the logo of the selected team stake 870 of the creating user 860, the date 880 of the contest between the real-world team of the selected team stake 870 and its competing team, the time 890 of the contest, the location 892 of the contest, the game amount 894 as set by the creating user 860, and an entry fee 896.

Upon accepting the join offer 810, a fantasy team 340 may be populated for the user 20 using the team that will be competing against the real world team of the creating user's selected team stake 870. In an embodiment, the user 20 may ten be required to substitute one or more players using the substitute player screen 600 of FIG. 6. After completing the substitution, if required, an acceptance of the join offer 810 may be transmitted to the gaming servers 40 and may specify the user's selected team, and substituted players 350.

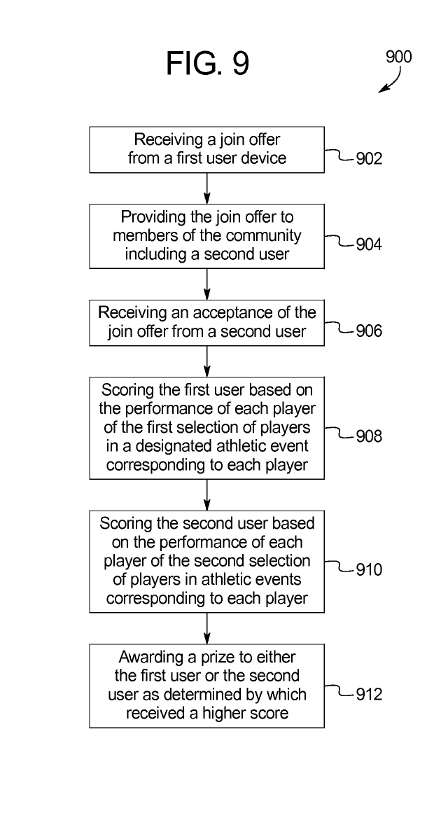

FIG. 9 illustrates a method 900 that may be executed by the gaming server 40 of the peer-to-peer gaming system 10 when carrying out the functionality described herein. First, at step 902, the gaming server 40 receives a join offer from the first user device. In an embodiment, the first user device is a user device of a first user of a user community, wherein the join offer identifies a first sports team to populate a first selection of players. At step 904, the gaming server 40 provides the join offer to members of the user community including a second user. In an embodiment, the second user device is a user device of the second user of the user community. Next, at step 906, the gaming server 40 receives, from the second user device, an acceptance of the join offer. The acceptance may identify a second team to populate a second selection of players. At step 908, the gaming server 40 scores the first user based on the performance of each player of the first selection of players in a designated athletic event corresponding to each player. And then, at step 910, the gaming server 40 scores the second user based on the performance of each player of the second selection of players in a designated athletic event corresponding to each player. Finally, at step 912, the gaming server 40 awards a prize to either the first user or the second user as determined by which received a higher score.

In some embodiments, the user 20 may have constraints on the players 350 he or she may choose, for example, the user 20 may be assigned certain players 350 or may be limited to choose from a specific group of players 350, such as, players 350 on teams participating in a specific event, a preselected team 250 for a contest that he can “accept or pass” on, a salary cap wherein each player 250 has an associated salary and the user 20 may choose players subject to the condition that the combined salaries must not exceed a specified amount.

Once the users 20 have selected, drafted, or been assigned their fantasy teams 340 (and agreed on the competition terms such as the dollar game amount of the entry), the game 15 may begin. The players 350 on a user's team may accumulate points based on their performance of each player 350 on the fantasy team 340 based on their real-world matchups during the period of the game 15 based on the player statistics 360 chosen by the administrator 50. If a user's team scores more points than the rival users 20 during the period of the game, the user 20 is awarded the winnings In an embodiment, the administrator 50 may choose statistics 360 such as: runs in baseball, points in basketball, points in football, goals in soccer, goals in hockey, runs and wickets in cricket. Alternatively, the statistics 360 may be determined on the basis of statistics for a player's position, such as, yards thrown for a quarterback, goals stopped by a goalie, strikeouts by a pitcher, etc.

In some embodiments, the gaming application 70 may import news feed or data feeds pertaining to the live sporting event of the community 60. These data feeds may include scores, player statistics, predictions, injury reports, etc. These data feeds may be displayed to the user 20 before, after or during the period of time in which the user is choosing players/teams, or at the user's desire, or after a team has been assigned or otherwise selected by the user 20.

In some embodiments, the gaming application 70 or the remote gaming servers 40 may generate a profile for a user 20 of the gaming application 70. The profile may be linked with third-party websites, such as social networks like Facebook, Twitter, Instagram, Snapchat, Linkedin, Tinder, Pinterest etc. The profile may include the favorite teams, favorite players, performance record, or other identifying characteristics of the user 20, and may be made public and/or visible to other users 20 at the discretion of the administrator and/or the user 20 depending on the settings within the gaming application 70.

The gaming application 70 may be a mobile device application and may include chat functionality to permit members of a community 60 to communicate with one another. For example, the user 20 may view other users in the community 60 via their profile or the stadium/arena rendering and initiate a chat with any of them. The users 20 may negotiate bets prior to an offer, or just build a community by joking around, taunting fans of the other team, etc. Additionally, the gaming application 70 may integrate a chat function where users 20 on the mobile application platform can automatically detect one another and choose by a method determined by the administrator to communicate within the application.

The gamin application 70 may include a feature whereby the user 20 can publish his thoughts, updates, results, etc. to the world at large via a third party platform that may be integrated by the administrator 50. For example, the user 20 may post a challenge to another user 20 or potential users 20 via Twitter, Facebook, Instagram, Snapchat, Pinterest or other digital media platforms.

The gaming application 70 may include push notification functions to permit advertising, sponsor notifications, etc. within the user interface featuring the fantasy sports competitions and/or wagers. For example, when the community 60 is based around a specific sports event, the gaming application 70 may receive push notifications from the promoters of the event or from the administrator 50 on behalf of advertisers, promoters, etc. Such push notifications may include free offers for merchandise, concessions, coupons or offers to participate in additional contests, etc.

In some embodiments, to create an interesting user interface, the gaming application 70 may include a 3-D rendering of all or part of the area defining the community. For example, when the community is based around a stadium or arena, the gaming application 70 may include a detailed rendering of such stadium or arena. The rendering of the stadium or arena may include avatars of the other users 20 of the gaming application 70. The other users 20 may be rendered at their seat, their current location or more generically “inside the stadium”. The avatar may be created by the administrator 50 or by using a profile picture of the user 20 entered by the user 20 in his or her profile. A user 20 viewing the rendering may move around the rendered area to search and view other users 20 and may see graphic depictions of the users 20 who are offering additional competitions and/or wagers that are also displayed in the lobby.

In an embodiment, the peer-to-peer gaming system 10 is embodied in a mobile device 30 including a memory storing the gaming application 70. In another embodiment, the peer-to-peer gaming system 10 is embodied in gaming servers 40 that coordinate games between the users 20. In further embodiments, the present invention is provided as a non-transitory computer-readable medium that includes the gaming application 70. In even further embodiments, the peer-to-peer gaming system 10 is embodied in a combination of mobile devices 30 and gaming servers 40 to provide the functionality described herein. Even further, the present invention may be embodied in methods that may be executed by the mobile devices 30, the gaming servers 40, and/or combinations of the mobile devices 30 and the gaming servers 40.

Referring back to FIG. 2, the user device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the user device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 30 is intended to operate. For example, the user device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the user device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 44. The memory 44 can include high-speed random access memory and/or non-volatile memory, such as one or more magnetic disk storage devices, one or more optical storage devices, and/or flash memory (e.g., NAND, NOR). The memory 44 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 44 may also store communication instructions 142 to facilitate communicating with one or more additional devices, one or more computers and/or one or more servers. The memory 44 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 44 may also store other software instructions controlling other processes and functions of the user device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 44.

Each of the above identified instructions and applications can correspond to a set of instructions for performing one or more functions described herein. These instructions need not be implemented as separate software programs, procedures, or modules. The memory 44 can include additional instructions or fewer instructions. Furthermore, various functions of the user device 30 may be implemented in hardware and/or in software, including in one or more signal processing and/or application specific integrated circuits. Accordingly, the user device 30, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the user device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a user device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A computer-implemented method performed by a gaming server in communication with a first user device and a second user device, comprising:
receiving a join offer from the first user device, wherein the first user device is a user device of a first user of a user community, wherein the join offer identifies a first sports team to populate a first selection of players, wherein the join offer includes a selection of a first player to exclude from the first selection of players and a selection of a second player to include in the first selection of players, wherein the first player is from the first sports team and the second player is from a sports team other than the first team;
providing the join offer to members of the user community including a second user, wherein the second user device is a user device of the second user of the user community;
receiving, from the second user device, an acceptance of the join offer, wherein the acceptance identifies a second team to populate a second selection of players;
scoring the first user based on the performance of each player of the first selection of players in a designated athletic event corresponding to each player;
scoring the second user based on the performance of each player of the second selection of players in a designated athletic event corresponding to each player; and
awarding a prize to either the first user or the second user as determined by which received a higher score.

2. The method of claim 1, wherein the user device of the first user is assigned to the user community in response to receiving a location identifier from the user device of the first user.

3. The method of claim 1, wherein the user community is associated with a real world sports event to be played between the first sports team and the second sports team.

4. The method of claim 1, wherein the acceptance of the join offer includes a selection of a first player to exclude from the second selection of players and a selection of a second player to include in the second selection of players, wherein the first player is from the second sports team and the second player is from a team other than the second team.

5. The method of claim 1, wherein the performance of each player is the number of points scored by the player.

6. A peer-to-peer gaming system comprising:
a first user device;
a second user device; and
a gaming server configured to:
receive a join offer from the first user device, wherein the first user device is a user device of a first user of a user community, wherein the join offer identifies a first sports team to populate a first selection of players, wherein the join offer includes a selection of a first player to exclude from the first selection of players and a selection of a second player to include in the first selection of players, wherein the first player is from the first sports team and the second player is from a sports team other than the first team;
provide the join offer to members of the user community including a second user, wherein the second user device is a user device of the second user of the user community;
receive, from the second user device, an acceptance of the join offer, wherein the acceptance identifies a second team to populate a second selection of players;
score the first user based on the performance of each player of the first selection of players in a designated athletic event corresponding to each player;
score the second user based on the performance of each player of the second selection of players in a designated athletic event corresponding to each player; and
award a prize to either the first user or the second user as determined by which received a higher score.

7. The system of claim 6, wherein the user device of the first user is assigned to the user community in response to receiving a location identifier from the user device of the first user.

8. The system of claim 6, wherein the user community is associated with a real world sports event to be played between the first sports team and the second sports team.

9. The system of claim 6, wherein the acceptance of the join offer includes a selection of a first player to exclude from the second selection of players and a selection of a second player to include in the second selection of players, wherein the first player is from the second sports team and the second player is from a team other than the second team.

10. The system of claim 6, wherein the performance of each player is the number of points scored by the player.

11. A non-transitory computer-medium which stores a program for peer-to-peer gaming, the program comprising instructions, that when executed by a controller that is in communication with a user interface and a gaming server, cause the controller to:
receive from a user, via the user interface, a selection of a first sports team to populate a first selection of players,
receive from a user, via the user interface, a selection of a first player to exclude from the first selection of players and a selection of a second player to include in the first selection of players, wherein the first player is from the first sports team and the second player is from a sports team other than the first team;
transmit a join offer to the gaming server, wherein the join offer identifies the first sports team and the selected first player and the selected second player; and
upon the remote server scoring the first selection of players based on the performance of each player of the first selection of players in a designated athletic event corresponding to each player and determining that a resulting score exceeds a score of a second selection of players, receiving a notification from the gaming server that the user has been awarded a prize.
